(19) United States
(12) Patent Application Publication
(10) Pub. No.: US 2005/0123887 A1
(43) Pub. Date: Jun. 9, 2005

(54) System and method for providing karaoke service using set-top box

(76) Inventors: Ye-Sun Joung, Daejon (KR); Injae Lee, Daejon (KR); Kyu-Heon Kim, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/866,401

(22) Filed: Jun. 10, 2004

(30) Foreign Application Priority Data
Dec. 5, 2003 (KR) 2003-88091

(51) Int. Cl. G11B 5/09; G11B 19/02

(52) U.S. Cl. 434/307 A

(57) ABSTRACT

A system and method for providing a karaoke service using an object-oriented audio/video karaoke contents through a digital TV using a set-top box connected to a cable network or internet is disclosed. The system for providing a karaoke service using the set-top box, the system includes: a user management server for authenticating and managing a user accessing the karaoke service system to use object-oriented audio/video karaoke contents through a cable network or internet; and a contents service server for providing an object-oriented audio/video karaoke contents list to an authenticated user and karaoke contents selected by the authenticated user to a set-top box.

### FIELD OF THE INVENTION

The present invention relates to a system and method for an audio/video karaoke service; and in particular, to a system and method for providing a karaoke service using an object-oriented audio/video (OOAV) karaoke contents through a digital TV (DTV) using a set-top box connected to a cable network or Internet.

### DESCRIPTION OF RELATED ART

The conventional karaoke service system is not convenient for not only purchasing expensive equipments but also updating karaoke contents.

In theses days, a fusion technology for broadcasting and telecommunication is developed actively. Internet functions (e.g., web surfing, file searching, etc.) used in a personal computer can be used in a digital TV (DTV) using a set-top box. Although the DTV can provide various functions and has merits of big screen and high quality audio and video, etc., services for the DTV can not be activated because there are not many contents using many functions of the DTV.

In an example of the prior art for providing a karaoke service using digital TV, there is a Korea patent Laid-open No.2003-0063675, entitled “A karaoke service system using a mobile terminal and DTV and a method thereof”. The conventional karaoke service system provides an embodiment of an optimum karaoke service which provides karaoke service in the internet through a mobile network to a mobile terminal and a DTV of the user.

For that, the prior art carries out a session connection in response to the wireless data telecommunication session connection request, requests a transmission of various data about a service music to a related user's mobile terminal, receives corresponding data adaptively, operates programs for playing each data related to music, synchronizes playing time each data mutually and plays synchronized data. However, the karaoke service in accordance with the prior art is limited to the wireless network and is positively necessary a data synchronization.

Therefore, it is strongly required that various services are provided through various networks and are developed through the DTV.

### SUMMARY OF THE INVENTION

It is, therefore, an object of the present invention to provide a system and method for providing a karaoke service using an object-oriented audio/video karaoke contents using a set-top box connected to a cable network or internet.

In accordance with an aspect of the present invention, there is provided a system for providing a karaoke service using a set-top box, the system including: a user management server for authenticating and managing a user accessing the karaoke service system to use object-oriented audio/video karaoke contents through a cable network or internet; and a contents service server for providing object-oriented audio/video karaoke contents list to an authenticated user and karaoke contents selected by the authenticated user to a set-top box.

In accordance with another aspect of the present invention, there is provided a method for providing a karaoke service using set-top box, the method including the steps of: a) requesting a karaoke service to a contents service server through a set-top box and authenticating a user based on user authentication information; b) providing an object-oriented audio/video karaoke contents list to the set-top box based on the authenticated information; and c) providing karaoke contents selected by the user in the object-oriented audio/video contents list.

In accordance with another aspect of the present invention, there is provided a method for providing a karaoke service using the set-top box, further including the step of: d) displaying the object-oriented audio/video contents list and playing the karaoke contents selected by the user in the digital TV.

The present invention relates to a system and method for an audio/video karaoke service; and in particular, to a system and method for providing a karaoke service using an object-oriented audio/video (OOAV) karaoke contents through a digital TV (DTV) using a set-top box connected to a cable network or Internet.

### BRIEF DESCRIPTION OF THE DRAWINGS

The above and other objects and features of the present invention will become apparent from the following description of the preferred embodiments given in conjunction with the accompanying drawings, in which:

FIG. 1 is a block diagram showing a karaoke service system in accordance with an embodiment of the present invention;

FIG. 2 is a flowchart illustrating a process for user authentication of a karaoke service method in accordance with an embodiment of the present invention;

FIG. 3 is a flowchart describing a process for transmitting karaoke contents list in a karaoke service method;

FIG. 4 is a flowchart describing a process for transmitting karaoke contents in a karaoke service method;

FIG. 5 is a diagram showing a structure of an object-oriented audio/video karaoke contents used in an embodiment of the present invention; and

FIG. 6 is a diagram showing an object-oriented audio/video karaoke contents list used in an embodiment of the present invention.

### DETAILED DESCRIPTION OF THE INVENTION

Other objects and aspects of the invention will become apparent from the following description of the embodiments with reference to the accompanying drawings, which is set forth hereinafter.

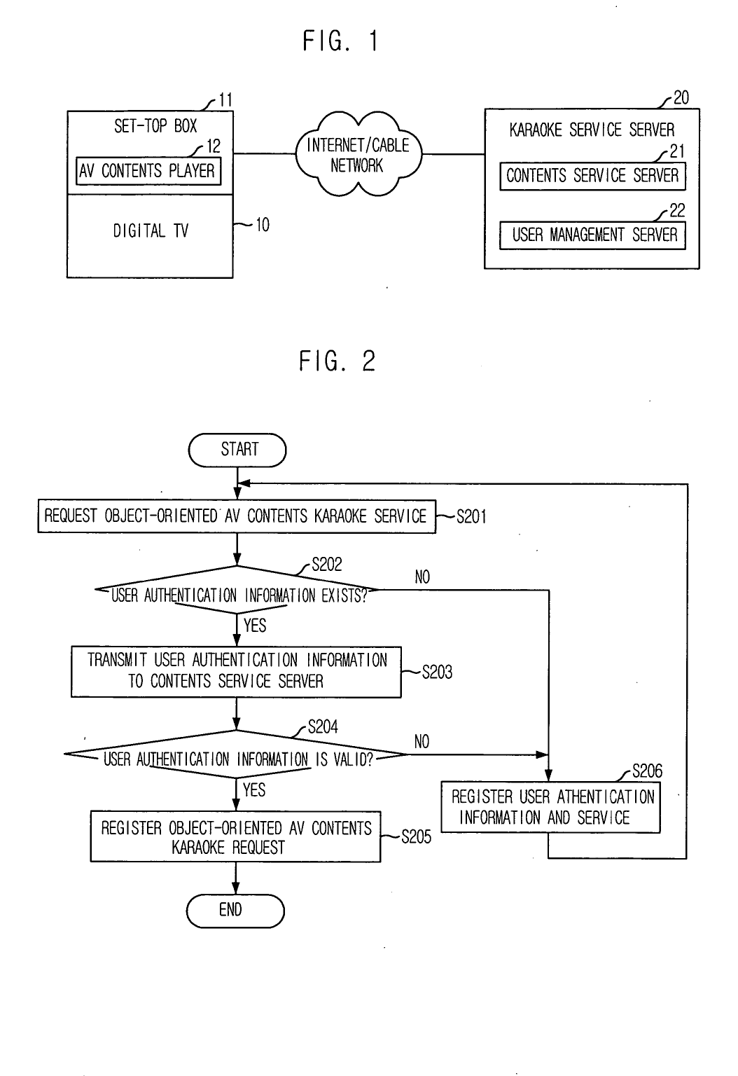

FIG. 1 is a block diagram showing a karaoke service system in accordance with an embodiment of the present invention.

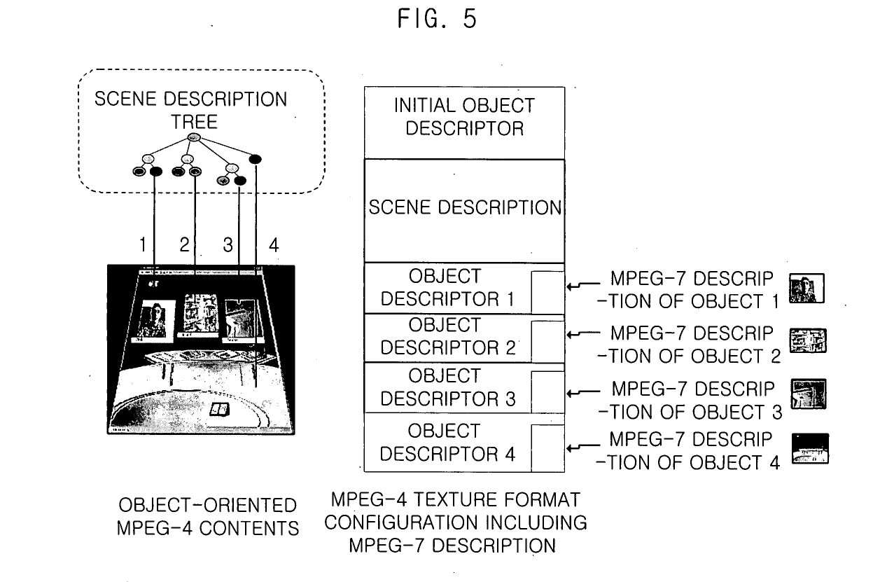

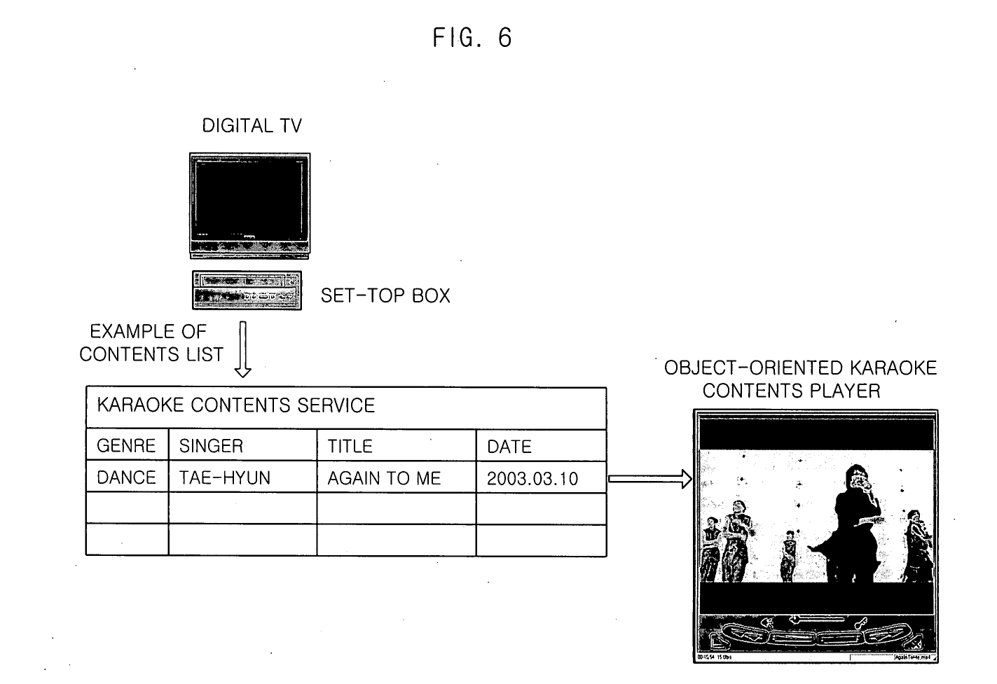

As shown, a karaoke service system in accordance with an embodiment of the present invention includes a contents service server 21 and a user management server 22. The user management server 22 manages and authenticates a user who accesses the karaoke service system through a cable network or internet in order to use an object-oriented AV (OOAV) karaoke contents service. The contents service server 21 provides an OOAV karaoke contents list categorized by a genre, a singer, an album, etc. and karaoke contents selected by the user to a set-top box 11.

Wherein OOAV karaoke contents are applied with Moving Picture Expert Group-7 (MPEG-7) meta data in order to search the contents based on MPEG-4 system and a structure of the OOAV karaoke contents is described in FIG. 5.

FIG. 5 is a diagram showing the structure of an object-oriented audio/video (OOAV) karaoke contents used in an embodiment of the present invention. MPEG-4 contents include a plurality of scenes, each of which is described by a scene description.

The scene description can store a scene as objects of a video, an audio, a stationary, etc., and the description can be expressed in a XML texture format and a binary format. Wherein the XML texture format includes in the sequence of an initial object description containing initialization information of the descriptors used in the scene description and the scene, the scene description and object descriptors.

Wherein the system makes a XML texture format file by adding MPEG-7 description data to object descriptors in order to contents applied with MPEG-7 meta data for searching based on MPEG-4 system in accordance with the present invention, appending the object descriptors behind initial object descriptor and scene description.

Also, the method makes the XML texture format by combining a data structure of MPEG-4 contents or a texture format file and a MPEG-7 description.

Also, the method is an embodiment for making the XML texture format file by combining the data structure of MPEG-4 contents or the texture format file and the MPEG-7 description and there are many variation of the method for combining the MPEG-4 contents texture format and the MPEG-7 description.

FIG. 6 is a diagram showing an object-oriented audio/video karaoke contents list used in an embodiment of the present invention.

AS shown, meta data which is expressed in MPEG-7 description can be used for retrieving MPEG-4 contents and can be configured variously according to users requesting OOAV karaoke contents service or according to applications.

An OOAV karaoke contents list is an example of a list provided when a user request the latest updated service list to a set-top box 11 connected to the DTV. In the list, there are genres, singers, contents titles and updating dates and the user selects contents in the provided list and gets contents service.

A method for searching audio/video (AV) contents uses MPEG-7 meta data. Because MPEG-7 meta data includes a descriptor describing AV contents characters, a description scheme including descriptors and a description definition language based on the XML describing description scheme, MPEG-7 meta data provides a method for searching effectively by complementing drawback of text-based search and contents-based searching.

Referring to FIG. 1 again, the digital TV (DTV) 10 outputs and displays the downloaded OOAV karaoke contents list and contents and an OOAV contents player 12 exists in the set-top box 11 and used for searching or playing the OOAV karaoke contents list and contents.

The set-top box 11 can connect to a karaoke service server 20 through a cable network or internet, and synchronized with a contents service server 12 servicing OOAV karaoke contents and a user management server 22 authenticating users. The set-top box 11 searches karaoke contents provided through a cable network or internet and equips the AV contents player 12 for playing in the DTV.

The OOAV contents player 12 carries out searching OOAV contents based on selections of users and providing corresponding services.

The contents service server 21 transmits user authentication information received from the set-top box 11 through a cable network or internet, authenticates the user using karaoke service (i.e., a DTV user) and transmits the OOAV karaoke content list and contents selected by the user to the set-top box 11.

The user management server 22 receives new user authentication information generated by user authentication information stored at the set-top box 11 or through the DTV 10 interface and carries out the user authentication.

FIG. 2 is a flowchart illustrating a user authentication process of the karaoke service method in accordance with an embodiment of the present invention. As shown, a user requests a karaoke service to the contents service server 21 through the set-top box 11, and the user management server 22 authenticates user authentication information.

At step S201, if a user requests karaoke service to the contents service server 21, at step S202, the user management server 22 determines whether authentication information of the user exist or not.

If the user authentication information exists in the set-top box 11, at step S203, the user management server 22 transmits the user authentication information to the contents service server 21. At step S204, the contents service server 21 checks whether the user authentication information received from the user management server 22 is valid or not.

If the authentication information is valid at the step S204, at step S205, the contents service server 21 registers the OOAV karaoke contents service request based on authenticated information.

However, if the user authentication information doesn't exist in the set-top box 11 or the received user authentication information is not valid, at step S206, the user registers user authentication information and services in the contents service server 21.

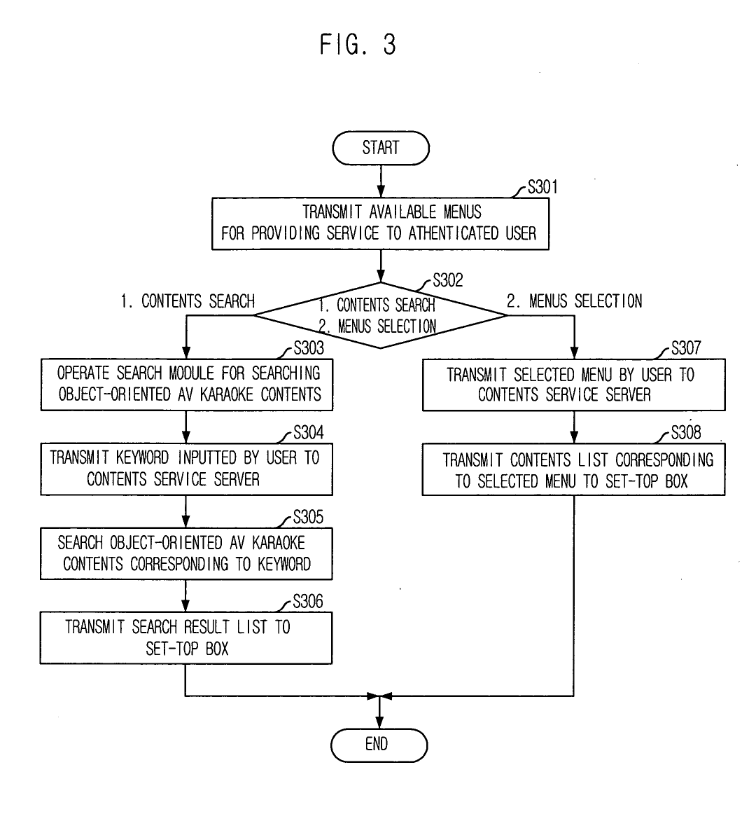

FIG. 3 is a flowchart describing a process for transmitting the karaoke contents list in the karaoke service method. As shown, contents search and various menus are provided to the user based on the authenticated information, and the OOAV karaoke contents list selected by the user is transmitted to the set-top box 11.

First of all, at step S301, the karaoke service system transmits available service menus to the authenticated user through the set-top box 11. At step S302, it is determined whether the user selects contents search or menu selection. If the user selects a contents searching menu, at step S303, the system operates an OOAV search module existing in the OOAV contents player 12 built in the set-top box 11, and at step S304, transmits a user's searching keyword to the contents service server 21. Then, at step S306, the contents service server 21 searches the OOAV contents list corresponding to the searching keyword, e.g., a title, a singer, an album, etc., and at step S306, transmits the OOAV list to the set-top box 11.

Wherein the searching keyword can be one of the searching conditions, e.g., songs, singers, albums, genres, countries, age, characteristic, etc. Herein, the genre is one of the attributes of songs and describes genre to which the song belongs, e.g., dance, jazz, ballad, etc. The county is one of the attributes of singer and describes country from which the singer comes. The age is related to songs, singers and albums and describes the ages related to those, e.g., in the early 1980s, golden pops, etc. The characteristic is one of the attributes of songs and describes that the song is for a specific season or the date, e.g., birthday, summer holidays, rainy day, etc.

Therefore, the contents service server 21 stores searching conditions of songs, singers, albums and genres. If the contents service server 21 receives a searching request for the song from the AV contents player 12 built in the set-top box 11, the contents service server 21 retrieves database in response to the searching request and transmits the searching result, the contents list, to the set-top box 11.

Meanwhile, at step S307, if the user selects the provided menus from the set-top box 11, e.g., genres, singers, albums, etc., the set-top box 11 transmits the menu selected by the user to the contents service server 21. The contents service server 21 transmits the OOAV list corresponding to the selected menu to the set-top box 11.

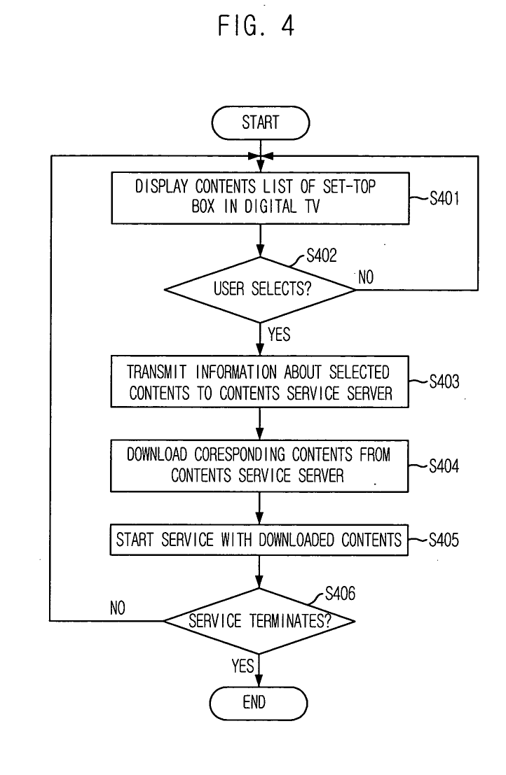

FIG. 4 is a flowchart describing a process for transmitting karaoke contents in a karaoke service method. As shown, receiving and servicing the OOAV karaoke contents selected by the user in the OOAV karaoke contents list transmitted from the contents service server 21.

Firstly, at step S401, the set-top box 11 displays the OOAV karaoke contents list in the DTV 10 through the OOAV contents player 12. At step S402, if the user selects a song on the menu of the displayed contents list, at step S403, the set-top box 11 transmits the information of the selected song to the contents service server 21. Then, at step S404, the contents service server 21 transmits the selected contents to the set-top box 11 and the set-top box 11 downloads the contents from the contents service server 21, and at step S405, services the downloaded contents through DTV 10.

Meanwhile, at step S402, if the user doesn't select contents in the displayed contents list, the content list is displayed in the DTV again. These processes are repeated until the user wants to terminate the service at step S406.

As above-mentioned, the method of the present invention can be embodied as a program and stored in recording media readable by a computer, e.g., CD-ROM, RAM, floppy disk, hard disk, magneto-optical disk, etc.

The karaoke service system of the present invention implements the karaoke service which uses OOAV contents through the set-top box connected through a cable network or Internet, to thereby improve the customer satisfaction and provide various additional services in the DTV to the user.

The present application contains subject matter related to Korean patent application no. 2003-79003, filed in the Korean intellectual Property Office on Nov. 10, 2003, the entire contents of which being incorporated herein by reference.

While the present invention has been described with respect to certain preferred embodiments, it will be apparent to those skilled in the art that various changes and modifications may be made without departing from the scope of the invention as defined in the following claims.

1. A system for providing a karaoke service using a set-top box, the system comprising:
a user management server for authenticating and managing a user accessing the karaoke service system to use object-oriented audio/video karaoke contents through a cable network or internet; and
a contents service server for providing object-oriented audio/video karaoke contents list to an authenticated user and karaoke contents selected by the authenticated user to a set-top box.

2. The system as recited in claim 1, wherein the set-top box searches karaoke contents provided through a cable network or internet and includes an audio/video contents player for displaying the object-oriented audio/video contents on a digital TV.

3. The system as recited in claim 2, wherein the object-oriented audio/video karaoke contents are Motion Picture Expert Group 7 (MPEG-7) meta data so as to be retrieved on MPEG-4 system.

4. A method for providing a karaoke service, the method comprising the steps of:
a) requesting a karaoke service to a contents service server through a set-top box and authenticating a user based on user authentication information;
b) providing an object-oriented audio/video karaoke contents list to the set-top box based on the authenticated information; and
c) providing karaoke contents selected by the user in the object-oriented audio/video contents list.

5. The method as recited in claim 4, further comprising the step of:
d) displaying the object-oriented audio/video contents list and playing the karaoke contents selected by the user in the digital TV.

6. The method as recited in claim 5, wherein object-oriented audio/video karaoke contents are Motion Picture Expert Group-7 (MPEG-7) meta data so as to be retrieved on MPEG-4 system.
